(19) United States
(12) Patent Application Publication
(10) Pub. No.: US 2006/0248899 A1
(43) Pub. Date: Nov. 9, 2006

(54) Method for producing gas turbines and gas turbine assembly

(76) Inventor: Uwe Borchert, Stralsund (DE)

Correspondence Address: BORDEN LADNER GERVAIS LLP, 1100-100 QUEEN ST, OTTAWA, ON, K1P 1J9, CA

(21) Appl. No.: 10/544,715

(22) PCT Filed: Feb. 11, 2003
(86) PCT No.: PCT/DE03/00386

§ 371 Date: Jun. 19, 2006

(51) Int. Cl. F02C 3/10

(52) U.S. Cl. 60/791

(57) ABSTRACT

The invention relates to a production method and to an assembly for a gas turbine system having a low output, which can be used as a shaft output gas turbine, a hot gas generator or as an air supplier. The aim of the invention is to provide a method with which small gas turbines can be produced with the most cost-effective components. The novel method is characterized in that at least one exhaust gas turboblower (1) of internal combustion engines, and air heaters (11, 12) that are manufactured or adapted with regard to the output parameters of the exhaust gas turboblower are joined to additional subassemblies, which are also adapted to said exhaust gas turboblower, in order to form a gas turbine. The outlet of the compressor (5) of the exhaust gas turboblower (1) is connected to the gas producer i.e. to the combustion chamber (12).

### PRIOR ART

Gas turbine assemblies, called gas turbines for short, are of great importance these days in drive technology. They are distinguished by a low specific weight, uncomplicated handling as well as by vibration-poor or vibration-free operation based on principle. On the other hand, there is a high manufacturing cost and consequently a high purchase price. Nevertheless, gas turbines have prevailed as a drive unit for mechanical powers of down to about 220 kW, if the gas-turbine specific advantages are to be fully used (e.g. aeronautical drives). Below this aforementioned power limit, gas turbines have little or no significance, primarily due to the high purchase price which is up to ten times greater in comparison to an equally powerful reciprocating engine. Reciprocating engines are still used in this circumstance today, although the use of a gas turbine would be technically more advantageous and comfortable (e.g. vibration-free). Compact gas turbines are designed and manufactured nowadays in such a way that a large number of the individual components must be developed and manufactured exclusively for this one purpose. Among other things, this also includes the rotors (turbine wheels, impeller compressors) and their blades, shafts, distributors and bearings which are especially expensive and demanding in the material selection. Replacing assembly groups and individual components is only possible to a limited degree or not at all when the turbine output and/or the type of turbine is to be changed. Assembly groups cannot simply be replaced, so that only a single type of gas turbine can be produced with the developed parts.

A method for effectively manufacturing small gas turbines is proposed in DE 3 701 519 A1. The invention relates to the manufacture of standard components from which modules are prefabricated. Gas turbines corresponding to the specific application are produced by combining these modules and connecting them by lines. Although high unit production numbers and consequently reductions in cost are obtained with this solution, a special production for turbine wheels, bearings, etc. is required. However, the technical expenditure and costs are still considerably higher than with internal combustion engines. The combination of modules always means a compromise with respect to the agreement of the parameters which result in power losses. Moreover, due to the required long connection lines, additional expenditures and great power losses (flow resistance, heat losses) result which have an especially negative affect with the low performance. The advantages of the spatially separate assembly groups are only desirable in a few applications. Predominantly, a compact drive unit is required.

### OBJECT OF THE INVENTION

The object of the invention is to create a method with which small gas turbines can be produced with cost-effective components. A further object is to develop assemblies in order to be able to create various compact gas turbines with these components.

According to the invention, this object is solved according to the features of claim 1.

Very cost-effective gas turbine assembly groups and components are provided for small gas turbines with this suprisingly simple solution.

Exhaust-gas driven turbines on reciprocating engines have been known for many years and in various sizes. They convert the energy of the exhaust-gas flow into compressor power for the engine charge. Their use for other applications or generally as gas turbines have been overlooked to date by the trade. Furthermore, to use existing turbochargers for producing gas turbines, the invention proposes that an air heater corresponding to the existing parameters of the turbocharger be created. The components are connected in such a way that the hot air from the air heater flows into the turbocharger and the compressed air from the compressor wheel into the air heater. The hot air flowing from the turbocharger can then be used for various applications. The air heater consists of a combustion chamber with a heat exchanger connected upstream and known accessories.

In a further embodiment of the invention according to claim 2, a second known turbocharger without an impeller compressor as a working turbine is connected with the output of the first turbocharger and a shaft-power gas turbine is created in this way.

According to claim 3, the combustion chamber is dimensioned and adjusted to the turbocharger in such a way, and/or the turbocharger(s) (1, 2, 3) selected with respect to the flow cross section in such a way that a differential pressure of 1.5 to 2.5 bar vis-à-vis the environment is produced in the combustion chamber. In this way, the assembly operates in the optimal range. According to claim 4, it is furthermore proposed that the compressor of the turbocharger is connected with the gas generator or combustion chamber in a branched manner. Thus, one part (primary air) of the compressed air current is led into the combustion zone and the other part (secondary air) behind the combustion zone. The secondary air is mixed with the freshly combusted gases and cool them to such an extent that the allowable turbine temperature is not exceeded. Furthermore, the division of the air currents is designed in such a way that it can be regulated, so that the afterburning and the exhaust-gas temperature is controllable.

Methods for producing various multistage assemblies of gas turbines are proposed in the further claims 5 to 7.

As a result of the new method, the use of a gas turbine instead of a reciprocating engine is also possible for smaller outputs (30 to 200 kW) for the first time. To date, with smaller gas turbines, the specific price per installed output was very high since the diversity of their individual components and their production costs was similarly high as those of a gas turbine with a relatively high rated output. The costs are greatly reduced by means of the new method due to the use of assembly groups (turbochargers) which are produced in large numbers and thus inexpensively and which were not originally designed for a gas turbine but are absolutely suitable. One can restrict oneself to the production of fewer connecting parts, lines of the working fluid, air heaters (combustion chamber, heat exchanger) and the assembly of small gas turbines. This is completed by the fuel system, lubricating system, control and starting mechanism.

To produce a small gas turbine from the aforementioned individual components, it is necessary on the one hand to adjust the air heater, in particular the combustion chamber, accurately to the output parameters of the turbocharger, such as rotational speed and thus mass flow, combustion temperature, equipment temperature, inlet and outlet velocity, geometry of the connections to the combustion chamber and to the turbine, inlet and outlet pressures, density of the gases and exhaust gas analysis. On the other hand, the assembly groups should be selected in such a way and adapted to the air heater that the characteristic curves of all assembly groups are adjusted to one another and that the required output and efficiency are attained.

In the present case, the complex shaped and high-grade turbine wheels, from a material point of view, and the also complex impeller compressors are left to the specialist, while the producer of the small gas turbine can restrict himself to the production of fewer connecting parts and the assembly of the small gas turbine.

A further advantage of this method lies in that a large number of different gas turbines can be produced as a result of combining various or several similar turbochargers. In this way, many different small gas turbines (with respect to rated output, rotational speed, thermodynamic circuit) can be produced with few assembly groups and with the aid of a computer-supported element selection. A small gas turbine of this type can be used independently of the arrangement and the number of turbochargers involved, both as a shaft-power gas turbine and as a hot gas generator or air supplier. It can be used as a drive machine with gears or with electrical transmission or both in aircraft, watercraft, hovercrafts, motor vehicles and rail-borne vehicles, crawler-type vehicles and similar vehicles as well as agricultural machines, building machines, emergency generators and power/heat coupling systems. Both high-grade and inferior, conventional and alternative liquid and gaseous fuels can be used.

In claims 8 to 13, various assemblies for exhaust-gas driven turbines in combination with air heaters are proposed which can be used for many applications.

### EXAMPLES

The method and the assembly shall be described in the following with reference to several examples.

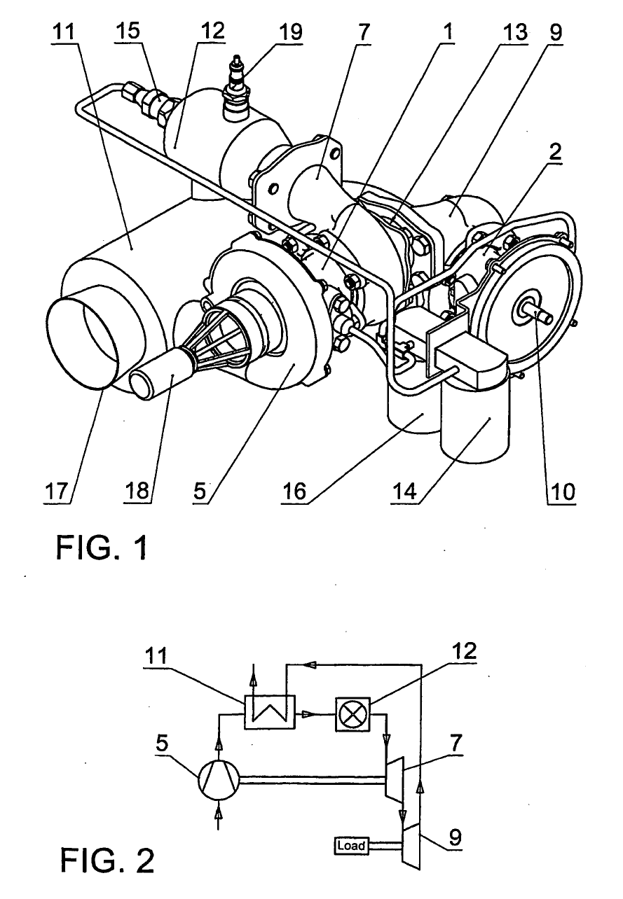

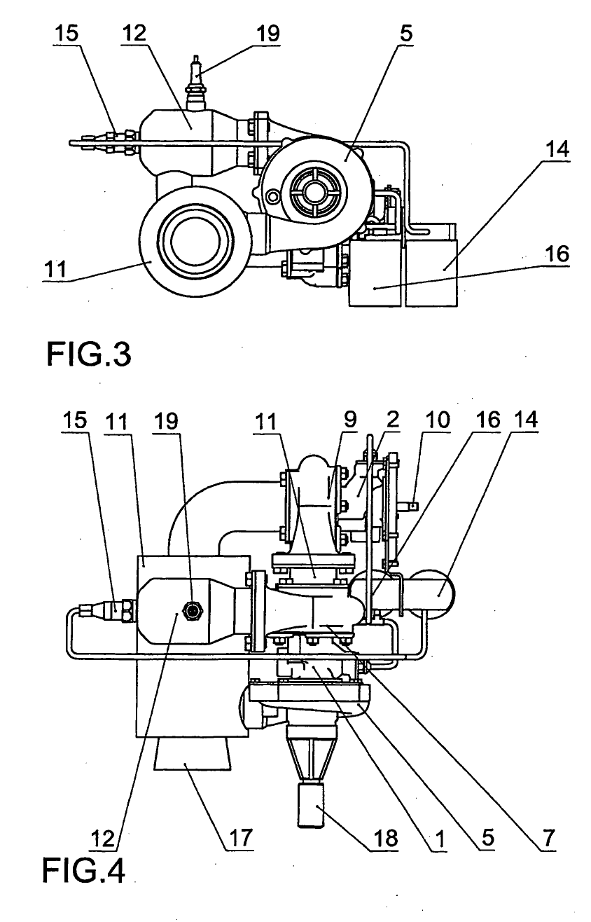

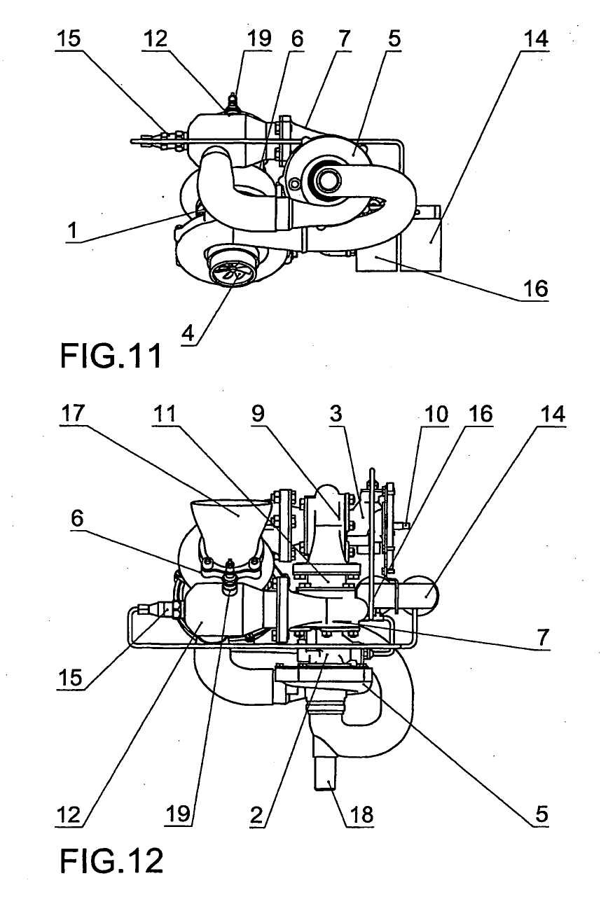

FIGS. 1 to 12 show the individual variations of the assembly and flow diagram.

A shaft-power turbine in a two-shaft design with a free-working turbine is shown in FIGS. 1 to 4 as example for the description in the thermodynamic circuit of gas turbine assemblies used most often. That is, from a thermodynamic point of view, this unit consists of a heat generator and a working turbine supported independently of the hot gas turbine.

The air is drawn in from the surroundings and compressed by the compressor 5. The compressor 5 belongs to the first turbocharger 1. The compressed air flows into the heat exchanger 11 in which the air is preheated by the exhaust-gas heat output. The compressed and preheated air then enters the combustion chamber 12 where a portion of the atmospheric oxygen is used for the combustion of the fuel which reaches into the combustion chamber 12 through the injection and air-injection valve 15. The combustion chamber 12 is designed in such a way that the high-tempered combustion product and the remaining air (secondary air) mix well and produce a technologically justifiable temperature of the working fluid now designated as inlet gas. The inlet gas flows through the distributor into the compressor turbine 7 which is also a component of the first turbocharger 1.

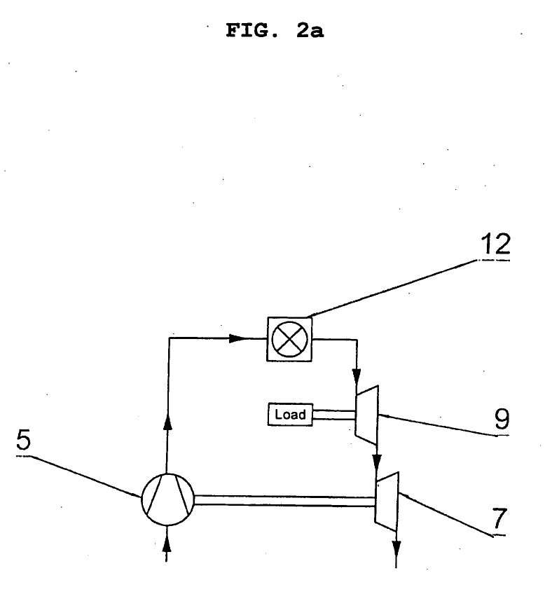

There, the gas delivers a large part of its energy to the compressor turbine wheel and therewith actuates the compressor 5. The gas then flows through the connecting piece 13 into the working turbine 9, which is a component of the second turbocharger 2. The mechanical power is there transmitted to the working turbine shaft 10 and is available there. Furthermore, the gas is conveyed to the heat exchanger 11. A part of the remaining energy of the working gas in the form of heat is there given to the compressed air to raise the efficiency of the machine. Finally, the fluid which can now be described as exhaust gas flows via the exhaust-gas diffuser 17 into the open. According to FIG. 2a, the inlet gas may also first be conveyed into the working turbine 9 and then into the compressor turbine 7 by an appropriate inversion of the arrangement.

The unit is actuated with the aid of the starter 18 which can simultaneously be a generator. The spark plug 19 serves as the first ignition of the fuel/air mixture in the starting phase. A fuel pump 14 or air-injection control is responsible for the fuel supply. The oil pump 16 conveys lubricant to the bearings. It is often not necessary for a drive unit that all shafts must be arranged in a coaxial or aligning manner. The unit shown in FIGS. 1 to 4 demonstrates the compactness with the selected arrangement. In this case, the shaft of the compressor and the working turbine shaft are arranged at 90° to one another. This arrangement has no effect on the function of the machine; however, it leads to small deviations.

Very many different small gas turbines of various sizes can be realized by combining turbochargers and connecting pieces of varying sizes. The type of gas turbine is determined by the intended application (providing hot gas, shaft power, radiated power or their combinations), the size by the required output and the quality and technology of the available turbocharger. All arrangements desired by a user and new combinations are possible in this case.

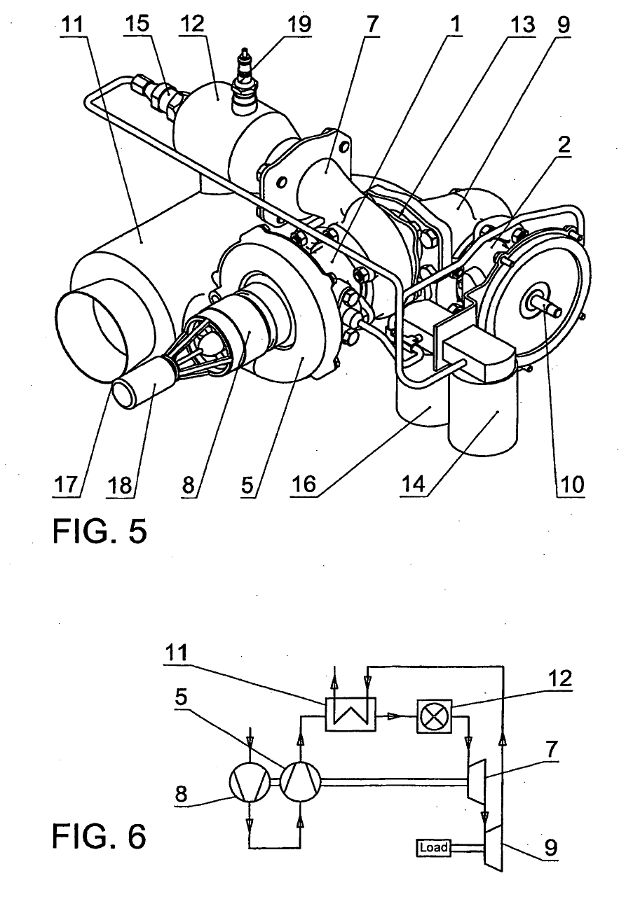

In FIGS. 5 to 12, further possibilities of the assembly of a small gas turbine consisting of several turbochargers are shown. FIGS. 5 and 6 show the assembly of FIGS. 1 to 4 with an additional axial step 8 arranged on the compressor shaft in front of the compressor 5. Said axial step 8 increases the pressure ratio which exists after compression.

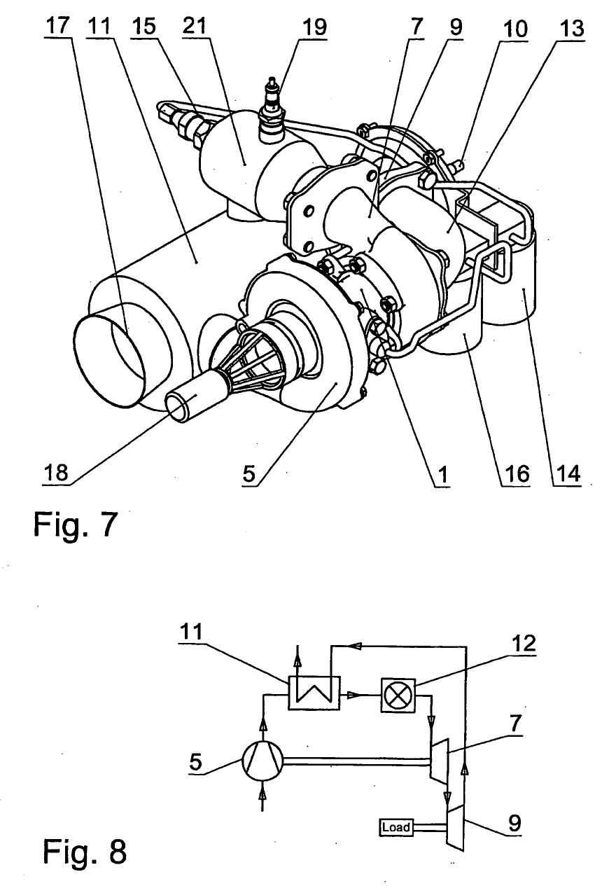

A small gas turbine of a two-shaft design with a compressor turbine and a free-working turbine is also shown in FIGS. 7 and 8. In this case, the working turbine (10) lies parallel to the shaft of the compressor 5, in contrast to the arrangements in FIGS. 1 to 6. This arrangement is obtained by using another connecting piece 13 and changing the connection on the heat exchanger 11.

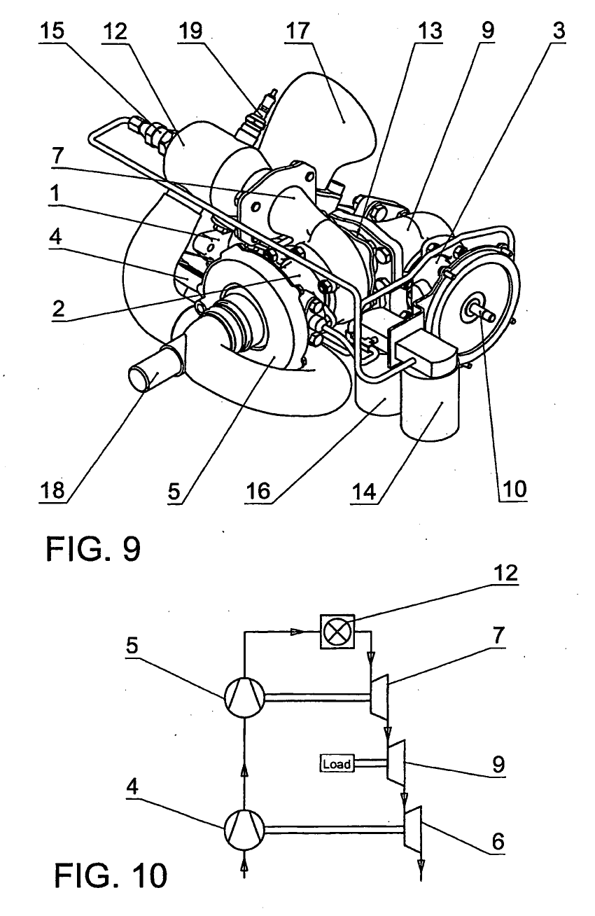

FIGS. 9 to 12 show a multistage arrangement of a small gas turbine in which a heat exchanger can be omitted due to the larger pressure ratio. A further advantage of this arrangement is in the lower specific weight. In this case, the air is first precompressed in the low-pressure compressor 4 and then brought to an overall higher pressure ratio than in the single-step compression by the high-pressure compressor 5 and supplied to the combustion chamber 12. The inlet gas then first of all flows through the high-pressure turbine 7 which drives the high-pressure compressor 5, then through the working turbine 9 and finally through the low-pressure turbine 6 which drives the low-pressure compressor 4. Finally, the exhaust gas flows through the exhaust-gas diffuser 17 into the environment.

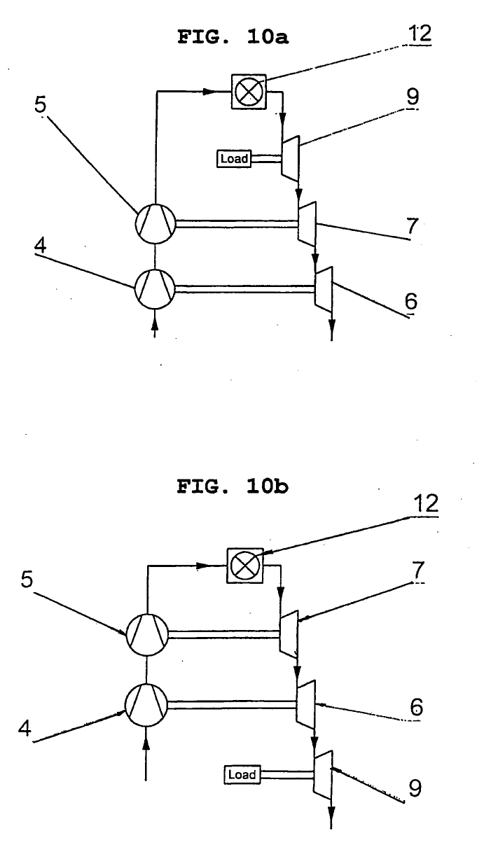

In this case also, another combination of the turbine assemblies is possible, as shown in FIGS. 10a and 10b.

### LIST OF REFERENCE NUMBERS

1 First turbocharger
2 Second turbocharger
3 Third turbocharger
4 Low-pressure compressor
5 Compressor/High-pressure compressor
6 Low-pressure turbine
7 Compressor turbine/High-pressure turbine
8 Axial step
9 Working turbine
10 Working turbine shaft
11 Heat exchanger Air heater
12 Combustion chamber Air heater
13 Connecting piece
14 Fuel pump
15 Air-injection valve
16 Oil pump
17 Exhaust-gas diffuser
18 Starter
19 Spark plug

1. Method for producing gas turbines in which prefabricated components or assembly groups are joined together to form gas turbines using turbochargers of internal-combustion engines produced in series, wherein the outlet of the compressor (5) of the turbocharger (1) is connected with the inlet of the gas generator or combustion chamber (12) and its outlet with the inlet of the exhaust-gas turbine, characterized in that
at least one further turbocharger (2, 3) is connected with the first turbocharger (1) in such a way that the exhaust gas flows through the exhaust-gas turbines without branching,
one of these turbochargers (2, 3) is rebuilt as a working turbine (9) in which the compressor is replaced by a coupling for a reduction in power,
and the outlet of the last turbocharger (2, 3) is connected with a heat exchanger (11) for the combustion air.

2. Method according to claim 1, characterized in that
a combustion chamber (12) adjusted to the output parameters of a shaft-power gas turbine, is produced with heat exchanger (11) and fuel system,
they are connected with a turbocharger (1) to form a hot gas generator,
and the latter are joined together with a second turbocharger (2) without compressor as working turbine (9), selected according to the output parameters of the hot gas generator to form a shaft-power gas turbine.

3. Method according to claim 1, characterized in that the combustion chamber (12) is dimensioned and adjusted to the turbocharger (1, or 2, or 3), which drives the compressor, or the turbocharger(s) (1, 2, 3) is/are selected with respect to the flow cross sections in such a way that a pressure differential of 1.5 to 2.5 bar is produced vis-à-vis the environment in the combustion chamber (12).

4. Method according to claim 1, characterized in that the compressor (5) of the turbocharger (1) is connected with the gas generator or the combustion chamber (12), in front of and behind its combustion zone, so as to be branched and adjustable, so that the after-burning and the exhaust-gas temperature is controllable.

5. Method according to claim 1, characterized in that several turbochargers (1, 2, 3) of internal-combustion engines air heaters (11, 12) produced in parallel or multistage, in series, in accordance with their output parameters, are joined with further assembly groups adapted to said turbochargers (1, 2, 3) to form a shaft-power gas turbine.

6. Method according to claim 1, characterized in that the outlet of the turbocharger (1) arranged first from a flow-line perspective, is connected directly or with a short connecting piece (13) with the inlet of the second turbocharger (2) arranged after it, so that the shafts of the turbocharger comprise an angle.

7. Method according to claim 1, characterized in that further assembly groups, such as heat exchanger (11), fuel system (14, 15), starter (18), control, etc. and parts for air heaters which are produced in series for various machines are connected directly or adapted to the turbochargers to form a gas turbine.

8. Gas turbine assembly according to the method according to claim 1, characterized in that the assembly groups such as turbochargers (1, 2, 3) of internal-combustion engines, heat exchangers (11), combustion chamber (12) and the like are connected directly or by way of short connecting pieces (13), predominantly at an angle, to form a compact unit.

9. Gas turbine assembly according to claim 8, characterized in that the outlet of the turbocharger (1) of an internal-combustion engine which acts as a hot gas generator is connected via a connecting piece (13) with the inlet of the turbocharger (2) of an internal-combustion engine which acts as a working turbine.

10. Gas turbine assembly according to claim 8, characterized in that the outlet of the combustion chamber (12) is connected with the inlet of the turbocharger (2) which acts as working turbine and the outlet of the turbocharger (2) is connected via a connecting piece (13) with the inlet of the turbocharger (1) which acts as compressor turbine.

11. Gas turbine assembly according to claim 8, characterized in that the turbines (6, 7, 9) of 3 turbochargers (1, 2, 3) are connected in series, two acting as two-stage compressor turbines (6, 7) and one as a working turbine (9), wherein the working turbine is arranged directly behind the combustion chamber (12), from a flow-line perspective, in the central or last position.

12. Gas turbine assembly according to claim 8, characterized in that the shafts comprise an angle of about 90°.

13. Gas turbine assembly according to claim 8, characterized in that the inlet of the turbocharger (1) is connected with the combustion chamber 12 in an axially aligning manner and that the heat exchanger is arranged below it parallel to the turbocharger 1.
